(19) United States
(12) Patent Application Publication
(10) Pub. No.: US 2021/0356283 A1
(43) Pub. Date: Nov. 18, 2021

(54) ROUTE GENERATION SYSTEM, ROUTE GENERATION METHOD, AND COMPUTER READABLE MEDIUM

(71) Applicant: MITSUBISHI ELECTRIC CORPORATION, Tokyo (JP)

(72) Inventors: Shu MURAYAMA, Tokyo (JP); Yi JING, Tokyo (JP)

(73) Assignee: MITSUBISHI ELECTRIC CORPORATION, Tokyo (JP)

(21) Appl. No.: 17/386,200

(22) Filed: Jul. 27, 2021

Related U.S. Application Data
(63) Continuation of application No. PCT/JP2019/011271, filed on Mar. 18, 2019.

(51) Int. Cl. G01C 21/34; G08G 1/01

(52) U.S. Cl. CPC G01C 21/3461; G08G 1/0129

(57) ABSTRACT

A traveling situation extraction unit (120) extracts, from a traffic accident database in which traffic accident scene information expressing a situation of a traffic accident scene is accumulated, a traveling situation of a vehicle corresponding to a traffic accident scene. An avoidance route generation unit (130) generates a plurality of avoidance routes to avoid the traffic accident scene on the basis of the traveling situation. An effectiveness determination unit (140) determines, for each of the plurality of avoidance routes, a value that expresses effectiveness, as an effective evaluation value. An effective route selection unit (150) selects a most effective avoidance route as an effective route from among the plurality of avoidance routes on the basis of an effective evaluation value of each of the plurality of avoidance routes. An effective information building unit (160) stores effective route information (172) in which the traffic accident scene and the effective route are associated with each other, to a storage unit (170).

### CROSS REFERENCE TO RELATED APPLICATIONS

This application is a Continuation of PCT International Application No. PCT/JP2019/011271, filed on Mar. 18, 2019, which is hereby expressly incorporated by reference into the present application.

### TECHNICAL FIELD

The present invention relates to a route generation system, a route generation method, and a route generation program and, in particular, to a route generation system, a route generation method, and a route generation program which generate an avoidance route on the basis of a traffic accident database.

### BACKGROUND ART

Conventional literature discloses a technique of predicting a danger by a skilled person and preparing a countermeasure in advance, thereby avoiding the danger.

In Patent Literature 1, a degree of danger is determined on the basis of motion information of own ship, motion information of another ship, and various types of obstacle information. A technique is disclosed which creates an avoidance route plan on the basis of a skill and knowledge base such that a future navigation course position of the own ship becomes an optimum future navigation course position conforming to a legal knowledge base. In Patent Literature 1, the future navigation course position according to arbitrary acceleration/deceleration and steering, which are skills possessed by a skilled ship steerer from experiences, is stored as a skill and knowledge base of an expert system. Also, matters to be complied with such as laws and rules are stored as the legal knowledge base.

### CITATION LIST

### Patent Literature

Patent Literature 1: JP H9-066894 A

### SUMMARY OF INVENTION

### Technical Problem

Patent Literature 1 has a problem that knowledge of a skilled steerer as an individual is limited and can only deal with limited scenes. Also, there is a problem that it is difficult to build a knowledge base to cope with all sorts of emergencies in a wide range. In addition, in the case of a knowledge base that is based on individual knowledge, personal differences are involved in the individual knowledge, and accordingly sometimes an optimum response for an emergency cannot be made.

It is an objective of the present invention to avoid an accident and to reduce damage at the time of a collision by generating an appropriate avoidance route from an actually occurring traffic situation, thereby realizing safe and secure autonomous driving and driving assistance.

### Solution to Problem

A route generation system according to the present invention includes:

a traveling situation extraction unit to extract, from a traffic accident database in which traffic accident scene information expressing a situation of the traffic accident scene is accumulated, a traveling situation of a vehicle corresponding to the traffic accident scene;

an avoidance route generation unit to generate a plurality of avoidance routes to avoid the traffic accident scene on a basis of the traveling situation;

an effectiveness determination unit to determine, for each of the plurality of avoidance routes, a value that expresses effectiveness, as an effective evaluation value;

an effective route selection unit to select a most effective avoidance route as an effective route from among the plurality of avoidance routes, on the basis of the effective evaluation value of each of the plurality of avoidance routes; and

an effective information building unit to store effective route information in which the traffic accident scene and the effective route are associated with each other, to a storage unit.

### Advantageous Effects of Invention

With a route generation device according to the present invention, an accident is avoided and damage at the time of a collision is reduced by generating an appropriate avoidance route as an effective route from an actually occurring traffic situation, thereby realizing safe and secure autonomous driving and driving assistance.

### BRIEF DESCRIPTION OF DRAWINGS

FIG. 1 illustrates a configuration example of a route generation system according to Embodiment 1.

FIG. 2 illustrates an example of generating a plurality of avoidance routes according to Embodiment 1.

FIG. 3 illustrates an example of an effectiveness evaluation model according to Embodiment 1.

FIG. 4 illustrates a configuration example of a model generation device which performs model generation processing according to Embodiment 1.

FIG. 5 illustrates an example of a learning data set for generating the effectiveness evaluation model according to Embodiment 1.

FIG. 6 illustrates an example of extracting a feature quantity vector from each avoidance route according to Embodiment 1.

FIG. 7 is a flowchart describing the model generation processing according to Embodiment 1.

FIG. 8 is a diagram for describing an example of a traffic accident scene according to Embodiment 1.

FIG. 9 is a flowchart describing route generation processing according to Embodiment 1.

FIG. 10 illustrates an example of generating a plurality of avoidance routes according to Embodiment 1.

FIG. 11 illustrates an example of a feature quantity vector V of an avoidance route 1 according to Embodiment 1.

FIG. 12 is a diagram illustrating a final score S for each effectiveness evaluation value of each avoidance route according to Embodiment 1.

FIG. 13 illustrates a calculation expression of the final score S according to Embodiment 1.

FIG. 14 illustrates a configuration example of a route generation device according to a modification of Embodiment 1.

### DESCRIPTION OF EMBODIMENTS

An embodiment of the present invention will be described below with referring to drawings. In the drawings, the same or equivalent portions are denoted by the same reference sign. In the description of embodiment, an explanation on the same or equivalent portions will be omitted or simplified, as necessary.

### Embodiment 1

### Description of Configurations

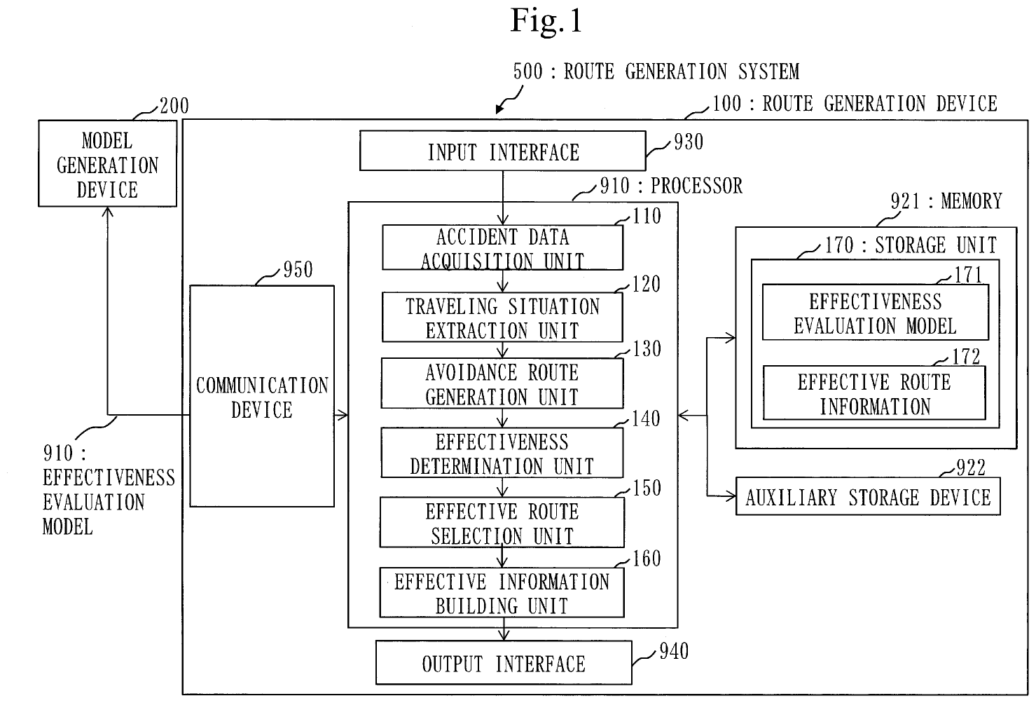

FIG. 1 illustrates a configuration example of a route generation system 500 according to the present embodiment.

The route generation system 500 is provided with a route generation device 100 and a model generation device 200. The route generation device 100 and the model generation device 200 are illustrated as separate devices. However, the route generation device 100 and the model generation device 200 may form one device. Alternatively, the model generation device 200 may be mounted in the route generation device 100.

The route generation device 100 is a computer. The route generation device 100 is provided with a processor 910 and is also provided with other hardware devices such as a memory 921, an auxiliary storage device 922, an input interface 930, an output interface 940, and a communication device 950. The processor 910 is connected to the other hardware devices via a signal line and controls the other hardware devices.

The route generation device 100 is provided with an accident data acquisition unit 110, a traveling situation extraction unit 120, an avoidance route generation unit 130, an effectiveness determination unit 140, an effective route selection unit 150, an effective information building unit 160, and a storage unit 170, as function elements. An effectiveness evaluation model 171 and effective route information 172 are stored in the storage unit 170.

Functions of the accident data acquisition unit 110, traveling situation extraction unit 120, avoidance route generation unit 130, effectiveness determination unit 140, effective route selection unit 150, and effective information building unit 160 are implemented by software. The storage unit 170 is provided to the memory 921 or auxiliary storage device 922.

The processor 910 is a device that runs a route generation program. The route generation program is a program that implements the functions of the accident data acquisition unit 110, traveling situation extraction unit 120, avoidance route generation unit 130, effectiveness determination unit 140, effective route selection unit 150, and effective information building unit 160.

The processor 910 is an Integrated Circuit (IC) that performs computation processing. Specific examples of the processor 910 include a Central Processing Unit (CPU), a Digital Signal Processor (DSP), and a Graphics Processing Unit (GPU).

The memory 921 is a storage device that stores data temporarily. Specific examples of the memory 921 include a Static Random-Access Memory (SRAM) and a Dynamic Random-Access Memory (DRAM).

The auxiliary storage device 922 is a storage device that keeps data. Specific examples of the auxiliary storage device 922 include an HDD. The auxiliary storage device 922 may be a portable storage medium such as an SD (registered trademark) memory card, a CF, a NAND flash, a flexible disk, an optical disk, a compact disk, a Blu-ray (registered trademark) Disc, and a DVD. Note that HDD stands for Hard Disk Drive, SD (registered trademark) stands for Secure Digital, CF stands for CompactFlash (registered trademark), and DVD stands for Digital Versatile Disk.

The input interface 930 is a port to be connected to an input device such as a mouse, a keyboard, and a touch panel. The input interface 930 is specifically a Universal Serial Bus (USB) terminal. The input interface 930 may be a port to be connected to a Local Area Network (LAN).

The output interface 940 is a port to which a cable of an output apparatus such as a display is to be connected. The output interface 940 is specifically a USB terminal or a High-Definition Multimedia Interface (HDMI; registered trademark) terminal. The display is specifically a Liquid Crystal Display (LCD).

The communication device 950 has a receiver and a transmitter. The communication device 950 is connected to a communication network such as a LAN, the Internet, and a telephone circuit by wireless connection. The communication device 950 is specifically a communication chip or a Network Interface Card (NIC).

The route generation program is read by the processor 910 and run by the processor 910. Not only the route generation program but also an Operating System (OS) is stored in the memory 921. The processor 910 runs the route generation program while running the OS. The route generation program and the OS may be stored in the auxiliary storage device 922. The route generation program and the OS which are stored in the auxiliary storage device 922 are loaded to the memory 921 and run by the processor 910. The route generation program may be incorporated in the OS partly or entirely.

The route generation device 100 may be provided with a plurality of processors that substitute for the processor 910. The plurality of processors share running of the route generation program. Each processor is a device that runs the route generation program just as the processor 910 does.

Data, information, signal values, and variable values which are utilized, processed, or outputted by the route generation program are stored in the memory 921, the auxiliary storage device 922, or a register or cache memory in the processor 910.

It is possible to replace “unit” in each of the accident data acquisition unit 110, the traveling situation extraction unit 120, the avoidance route generation unit 130, the effectiveness determination unit 140, the effective route selection unit 150, and the effective information building unit 160 by “process”, “procedure”, or “stage”. It is possible to replace “process” in each of an accident data acquisition process, a traveling situation extraction process, an avoidance route generation process, an effectiveness determination process, an effective route selection process, and an effective information building process by “program”, “program product”, or “computer-readable recording medium recorded with a program”.

The route generation program causes the computer to execute each process, each procedure, or each stage which is a unit mentioned above with its “unit” being replaced by “process”, “procedure”, or “stage”. The route generation method is a method implemented by the route generation device 100 running the route generation program.

The route generation program may be provided as being stored in a computer-readable recording medium. The route generation program may be provided as a program product.

### Overview of Functions

The accident data acquisition unit 110 acquires traffic accident scene information from an existing huge traffic accident database. Traffic accident scene information expressing a situation of a traffic accident scene is accumulated in the traffic accident database.

The traveling situation extraction unit 120 extracts a traveling situation of a vehicle corresponding to the traffic accident scene. The traveling situation of the vehicle includes a velocity and a direction of the vehicle. Specifically, the traveling situation extraction unit 120 extracts: a traveling situation such as a position and speed of the vehicle; a road surface condition; a road shape; a traveling direction; and a position, speed, and traveling direction of an oncoming car, from the traffic accident scene information acquired by the accident data acquisition unit 110. Note that the vehicle signifies an own vehicle.

The avoidance route generation unit 130 generates a plurality of avoidance routes 40 to avoid the traffic accident scene on the basis of the traveling situation. An avoidance route is a route that is considered to allow to avoid some kind of accident such as a property damage accident, an accident resulting in injury or death, a rear-end collision accident, and a secondary disaster. The avoidance route generation unit 130 generates the plurality of avoidance routes 40 using elements of the traveling situation extracted by the traveling situation extraction unit 120.

Specifically, first, an emergency braking distance is determined from the speed and direction of the vehicle. For example, assuming that the vehicle is traveling at a velocity of 40 km/h, if the road surface condition is dry (frictional coefficient=0.8), the braking distance is 7.9 m.

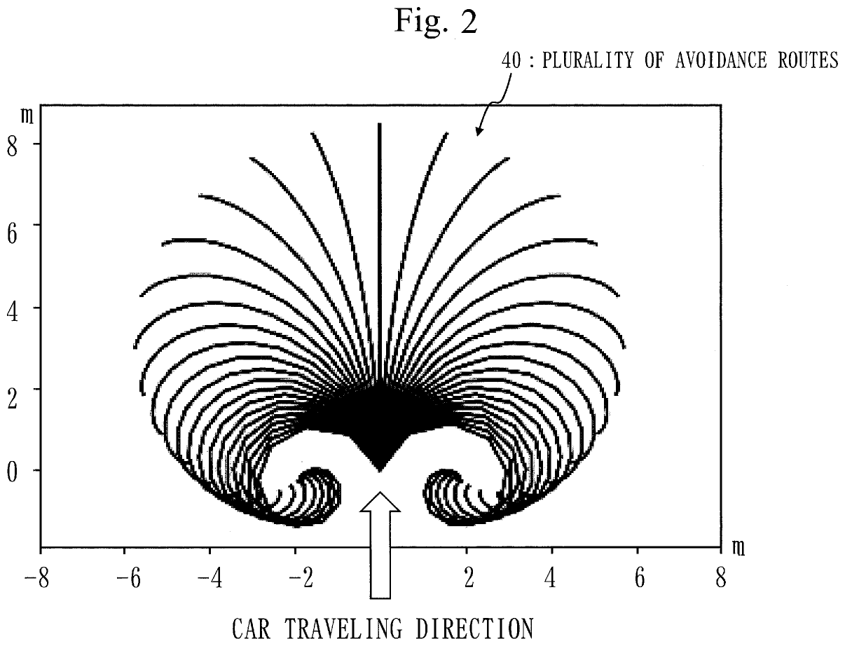

FIG. 2 is a diagram illustrating an example of generating the plurality of avoidance routes 40 according to the present embodiment.

As illustrated in FIG. 2 where the leftward direction is expressed by minus and the rightward direction is expressed by plus, when a direction change is applied, a plurality of paths are displayed which are generated by changing the direction in units of 2 degrees within a range of −40 degrees to +40 degrees. For the sake of simple explanation, a dynamic characteristic such as slipping which occurs when a car is making a sharp curve is omitted. Also, for the sake of simple explanation, an angle change amount in route generation is assumed to be constant. However, it is possible to change the angle during an actual braking process.

The effectiveness determination unit 140 determines, for each of the plurality of avoidance routes 40, a value that expresses effectiveness, as an effective evaluation value. The effectiveness determination unit 140 evaluates the effectiveness of each of the plurality of avoidance routes 40 generated by the avoidance route generation unit 130, and determines the effective evaluation value for each of the plurality of avoidance routes 40. The effectiveness determination unit 140 is also called an effective route evaluation value.

In the present embodiment, for example, the maximum entropy method can be utilized as an effective route evaluation method. When evaluating an avoidance route, subjective evaluation is performed with utilizing a statistical method, on the basis of an avoidance route generated in advance. Regarding wow likely an evaluation value corresponding to an evaluating feature quantity of that avoidance route is, it is judged based on a pair of an avoidance route and a subjective evaluation value. This data pair is adjusted manually in advance. For the sake of simple explanation, the subjective evaluation will be explained by 5-stage evaluation of 1 to 5. For example, a plurality of persons, who are experts, in charge of evaluation rate each of the plurality of avoidance routes with a score of 1 to 5. A high score means that the route is highly appropriate.

The effectiveness determination unit 140 determines the effective evaluation value of each of the plurality of avoidance routes using the effectiveness evaluation model 171 indicating correspondence between an effective evaluation value P and a feature quantity T which expresses a feature of the avoidance route.

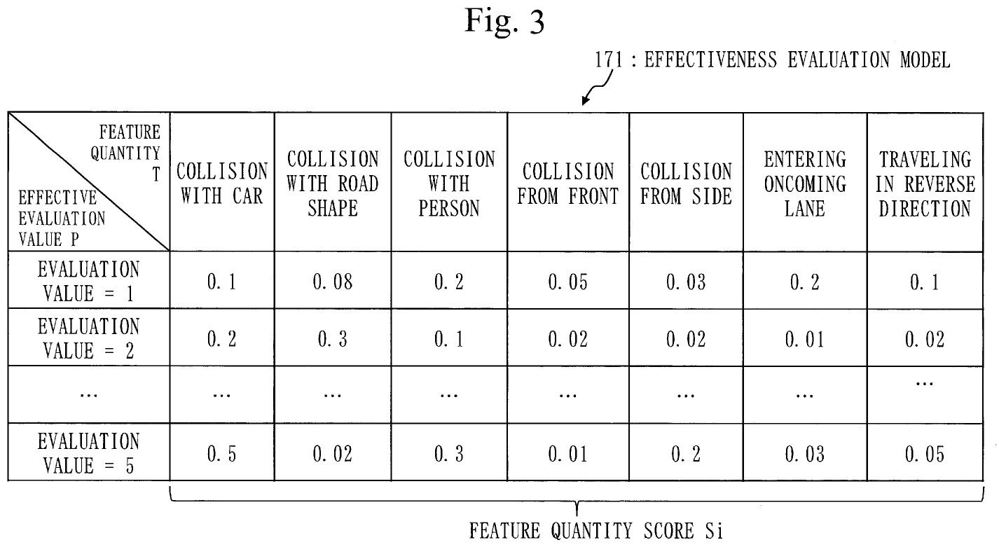

FIG. 3 is a diagram illustrating an example of the effectiveness evaluation model 171 according to the present embodiment.

The effectiveness evaluation model 171 to be used by the effectiveness determination unit 140 is stored in the storage unit 170. The effectiveness evaluation model 171 is created in advance by a model generation device 200 to be described later, and is stored in the storage unit 170. As illustrated in FIG. 3, in the effectiveness evaluation model 171, a strength of a relationship between each feature quantity T of an avoidance route and the effective evaluation value P is described as a feature quantity score Si. There are seven (i=7) evaluating feature quantities, as follows.

(1) Collision with a car or not

(2) Collision with a road shape or not

(3) Collision with a person or not

(4) Collision from the front or not

(5) Collision from the side or not

(6) Entering an oncoming lane or not

(7) Traveling in a reverse direction or not

The effective route selection unit 150 selects the most effective avoidance route as an effective route from among the plurality of avoidance routes 40, on the basis of the effective evaluation value of each of the plurality of avoidance routes 40. The effective route selection unit 150 selects an avoidance route whose effective evaluation value determined by the effectiveness determination unit 140 is the highest, as the effective route, and outputs the effective route to the effective information building unit 160.

The effective information building unit 160 stores the effective route information 172 in which a traffic accident scene and an effective route are associated with each other, to the storage unit 170. The effective route information 172 is also called a knowledge base. The effective information building unit 160 is also called a knowledge base building unit.

### Description of Operations

Operations of the route generation system 500 according to the present embodiment will be described.

First, model generation processing of generating the effectiveness evaluation model 171 will be described. The route generation system 500 is provided with the model generation device 200 which generates the effectiveness evaluation model 171.

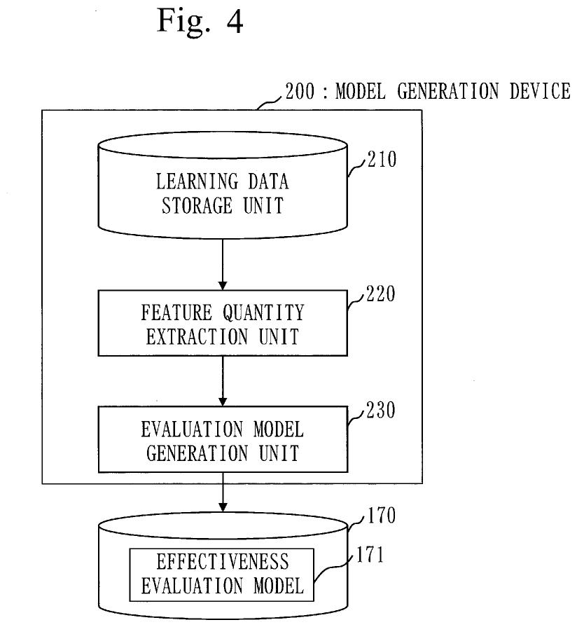

FIG. 4 illustrates a configuration example of the model generation device 200 which performs the model generation processing according to the present embodiment. The model generation device 200 is provided with a learning data storage unit 210, a feature quantity extraction unit 220, and an evaluation model generation unit 230, as function elements. The model generation device 200 is a computer, and its hardware configuration is the same as that of the route generation device 100. The model generation device 200 generates the effectiveness evaluation model 171. The generated effectiveness evaluation model 171 is stored in the storage unit 170 of the route generation device 100.

The learning data storage unit 210 stores a learning data set 211 in which each of the plurality of avoidance routes 40 and a preset subjective evaluation value are associated with each other. The subjective evaluation value is a value being set by an expert in advance to express an effectiveness of an avoidance route. The learning data storage unit 210 stores a pair formed of an avoidance route and a subjective evaluation value which expresses an effectiveness of the avoidance route, as the learning data set 211.

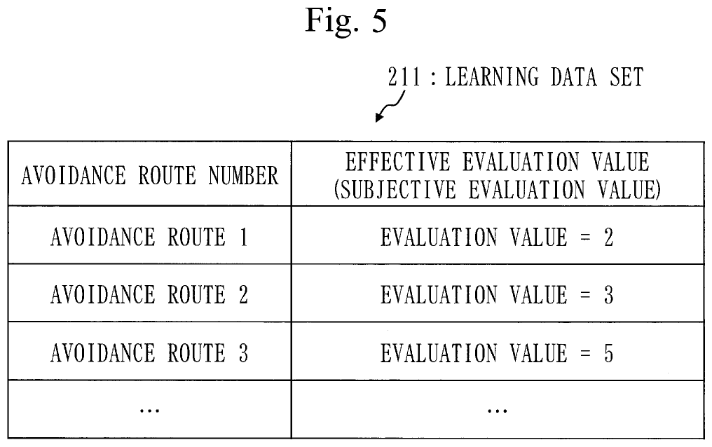

FIG. 5 is a diagram illustrating an example of the learning data set 211 for generating an effectiveness evaluation model according to the present embodiment.

In the model generation device 200, the learning data storage unit 210 numbers the plurality of avoidance routes 40 of FIG. 2 with route numbers, and stores each pair formed of the avoidance route and the corresponding effective evaluation value (subjective evaluation value) to a storage apparatus as the learning data set 211. This effective evaluation value (subjective evaluation value) has been given through 5-level subjective evaluation in advance by the expert.

The feature quantity extraction unit 220 extracts a feature quantity vector V expressing feature quantities to evaluate effectiveness of each of the plurality of avoidance routes 40 on the basis of the learning data set 211. Specifically, the feature quantity extraction unit 220 extracts a feature quantity vector V from each of the plurality of avoidance routes 40 of FIG. 2. The effectiveness evaluation model 171 indicating the corresponding relationship between a feature quantity and an effective evaluation value is generated with using the extracted feature quantity vector V. For example, an on-hot model is used to extract the feature quantity. According to a specific example, if collision with a car occurs even on an avoidance route, the feature quantity of the collision with the car on this avoidance route is 1. In this case, a feature quantity vector V is generated from each avoidance route by this method.

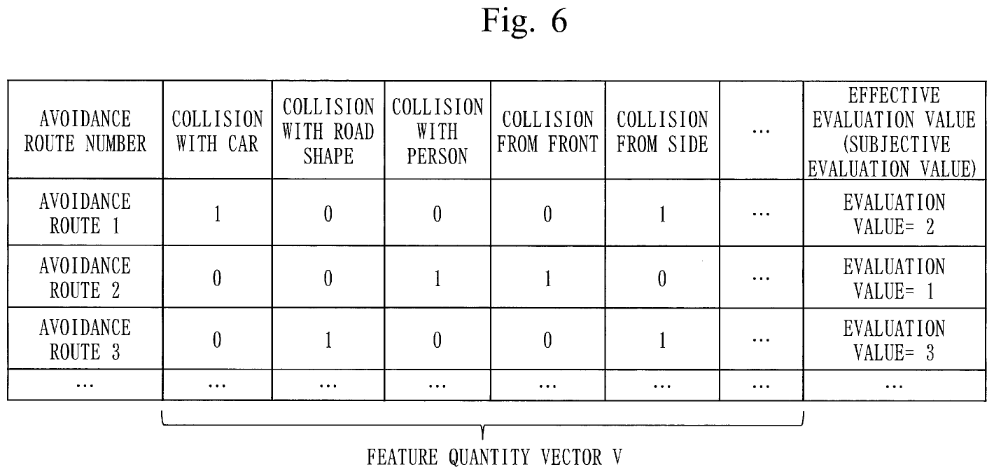

FIG. 6 is a diagram illustrating an example of extracting a feature quantity vector V from each avoidance route according to the present embodiment. Each avoidance route is associated with a pair formed of a feature quantity vector V and an effective evaluation value (subjective evaluation value).

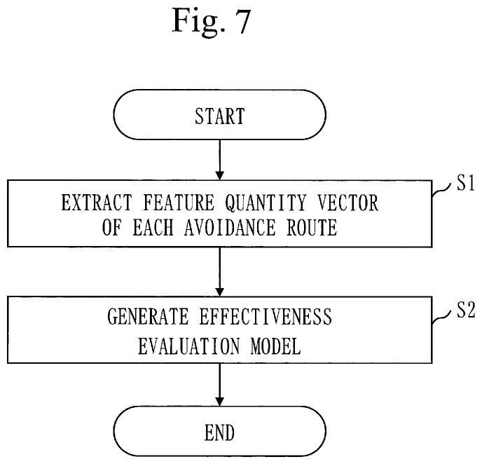

FIG. 7 is a flowchart describing the model generation processing according to the present embodiment.

In step S1, the feature quantity extraction unit 220 extracts the feature quantity vector V expressing feature quantities for evaluating the effectiveness of the avoidance route, from the learning data set 211. Specifically, the feature quantity extraction unit 220 extracts the feature quantity vector V from each of the plurality of avoidance routes 40. The feature quantity extraction unit 220 outputs the feature quantity vector V to the evaluation model generation unit 230.

In step S2, the evaluation model generation unit 230 generates the effectiveness evaluation model 171 using the learning data set 211 and the feature quantity vector V of each of the plurality of avoidance routes 40. Specifically, the evaluation model generation unit 230 generates the effectiveness evaluation model 171 using a pair of the feature quantity vector V obtained from the feature quantity extraction unit 220 and the effective evaluation value (subjective evaluation value). For example, an avoidance route that allows a collision with a pedestrian cannot be regarded a good avoidance route, and is accordingly rated with a low evaluation value. Therefore, whether the collision is with a pedestrian signifies. The evaluation model generation unit 230 performs the same processing as this on each piece of data included in the learning data set 211, and optimizes significance of each feature quantity item. Then, the evaluation model generation unit 230 performs calculation on each effective evaluation value such that the significance of each feature quantity item is optimized, to finally generate the effectiveness evaluation model 171 as illustrated in FIG. 3.

Route generation processing by the route generation device 100 will be described.

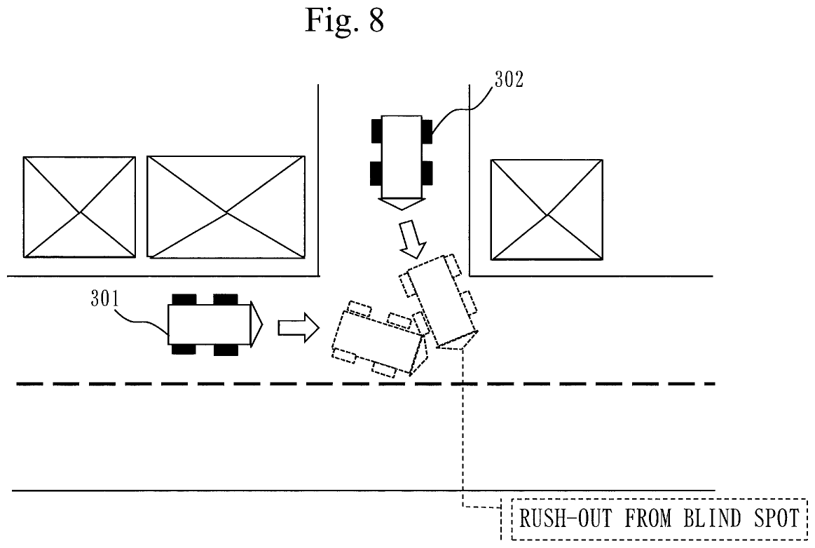

FIG. 8 is a diagram for describing an example of a traffic accident scene according to the present embodiment.

FIG. 8 illustrates a traffic accident scene where when an own vehicle 301 is passing through a non-signalized intersection from the left to the right at a velocity of 40 km/h, another vehicle 302 turning left appears suddenly from a blind spot, and the own vehicle 301 cannot avoid this another vehicle 302 and collides with it.

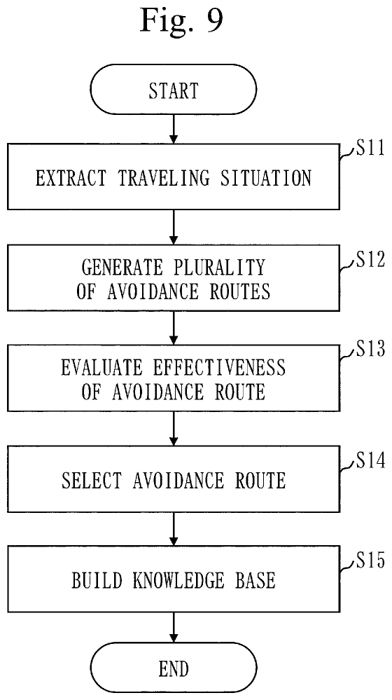

FIG. 9 is a flowchart describing the route generation processing according to the present embodiment.

Note that the own vehicle 301 is traveling from the left to the right, as in the traffic accident scene illustrated in FIG. 8.

In step S11, the accident data acquisition unit 110 acquires the traffic accident scene from the traffic accident database. Then, the traveling situation extraction unit 120 extracts a traveling situation from the traffic accident scene.

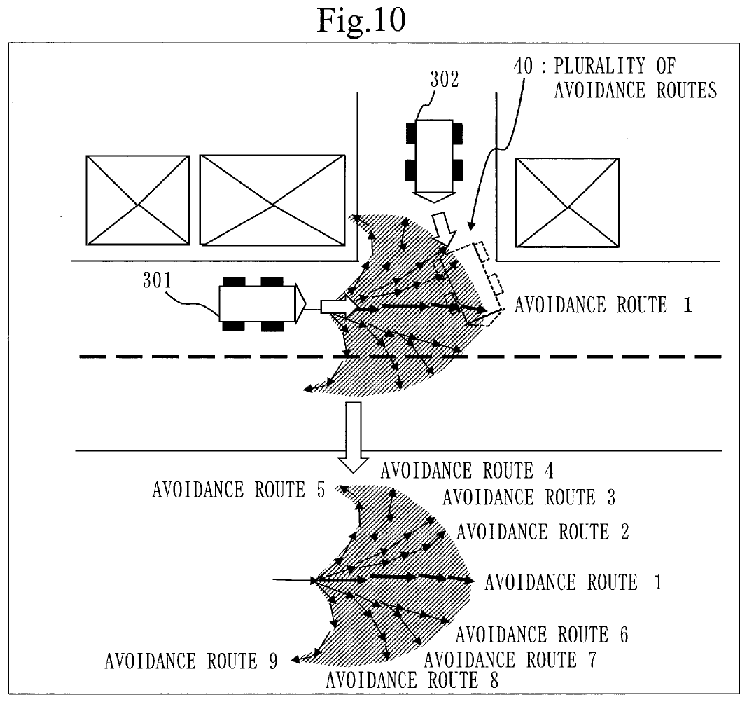

FIG. 10 is a diagram illustrating an example of generating a plurality of avoidance routes according to the present embodiment.

In step S12, the avoidance route generation unit 130 generates a plurality of avoidance routes 40 for a case where the own vehicle 301 applies a sudden brake from a present position. Specifically, the plurality of avoidance routes 40 are generated by the avoidance route generation unit 130 as illustrated in FIG. 10.

In step S13, the effectiveness determination unit 140 acquires the plurality of avoidance routes 40 and evaluates effectiveness of each avoidance route. Specifically, the effectiveness determination unit 140 determines an effective evaluation value for each of the plurality of avoidance routes 40.

The effectiveness determination unit 140 calculates, for each avoidance route out of the plurality of avoidance routes, a final score S expressing a height of probability that an effective evaluation value might be obtained about each of the plurality of effective evaluation values, using the effectiveness evaluation model 171 and the feature quantity vector V of each of the plurality of avoidance routes 40. Then, the effectiveness determination unit 140 determines an effective evaluation value having a highest final score S, as the effective evaluation value P of this avoidance route, among the plurality of effective evaluation values. At this time, the effectiveness determination unit 140 calculates feature quantity scores Si of the feature quantities per effective evaluation value of the plurality of effective evaluation values, and calculates a sum of the feature quantity scores Si as the final score S.

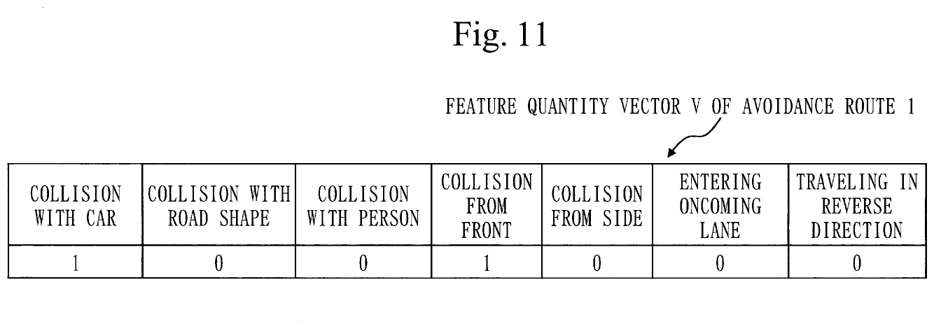

FIG. 11 is a diagram illustrating an example of the feature quantity vector V of the avoidance route 1 according to the present embodiment.

The effectiveness determination unit 140 extracts a feature quantity vector V for each avoidance route. For example, as illustrated in FIG. 11, with the avoidance route 1, the own vehicle collides with a car, so a feature quantity of the collision with the car is 1. A feature quantity of a collision with a road shape or pedestrian is 0. When the collision is from the front, a feature quantity of the collision from the front is 1. The feature quantities of the avoidance route 1 are vectorized by this modeling method.

Subsequently, about each avoidance route, the effectiveness determination unit 140 acquires feature quantity scores Si expressing scores of feature quantities per effective evaluation value, using the effectiveness evaluation model 171 stored in the storage unit 170. Then, about each avoidance route, the effectiveness determination unit 140 calculates a sum of the feature quantity scores Si, as the final score S per effective evaluation value.

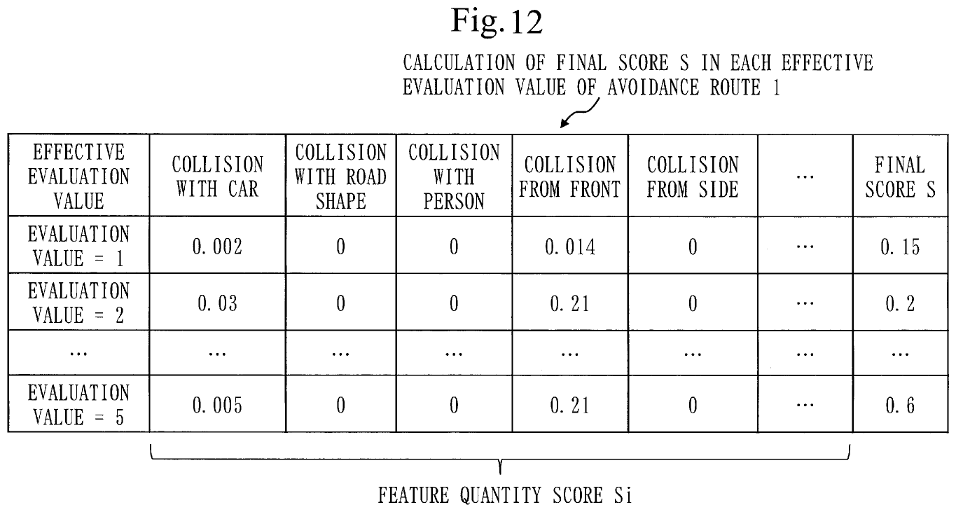

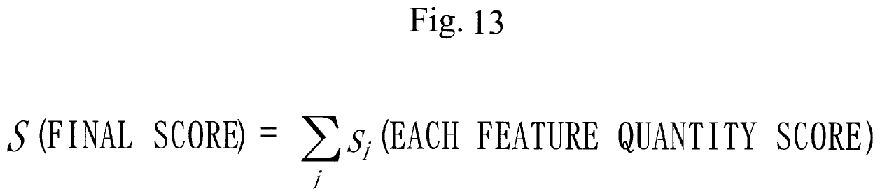

FIG. 12 is a diagram illustrating a final score S for each effectiveness evaluation value of each avoidance route according to the present embodiment. FIG. 13 illustrates a calculation expression of the final score S according to the present embodiment.

As illustrated in FIG. 12, the effectiveness determination unit 140 determines the feature quantity scores Si per effective evaluation value of the avoidance route 1, using the feature quantity vector V of the avoidance route 1 and the effectiveness evaluation model 171. Then, the effectiveness determination unit 140 calculates the final score S per effective evaluation value of the avoidance route 1, using the calculation expression of FIG. 13. The final score S expresses the likelihood of the corresponding effective evaluation value, that is, the height of probability that the corresponding effective evaluation value might be obtained.

Note that Si represents a score of an ith feature quantity of an avoidance route whose final score S is to be calculated. The final score S is a sum of the feature quantity scores Si of the avoidance route as a calculation target. Note that i is a natural number and expresses a count of feature quantities.

The effectiveness determination unit 140 determines an effective evaluation value having a highest final score S, as the effective evaluation value of the avoidance route. The effectiveness determination unit 140 outputs the determined effective evaluation value of the avoidance route to the effective route selection unit 150.

In the example of FIG. 12, the effectiveness determination unit 140 determines effective evaluation value 5 having a highest final score S (0.6), as the effective evaluation value of the avoidance route 1.

The effective route selection unit 150 selects the most effective route as an effective route Rb from among the plurality of avoidance routes 40 on the basis of each effective evaluation value of each of the plurality of avoidance routes 40.

Specifically, the effectiveness determination unit 140 determines the effective evaluation value for each of the plurality of avoidance routes of FIG. 10 which are avoidance route 1 to avoidance route 9. The effective route selection unit 150 selects an avoidance route corresponding to a highest-value effective evaluation value, as the effective route Rb from among the individual effective evaluation values of the avoidance route 1 to the avoidance route 9, and outputs the selected effective route Rb to the effective information building unit 160. There may be a plurality of effective routes Rb.

The effective information building unit 160 stores in the storage unit 170 the effective route information 172 in which a traffic accident scene and an effective route Rb are associated with each other. At this time, the effective information building unit 160 stores the effective route information 172 to the storage unit 170 in a knowledge-base format.

Specifically, the effective information building unit 160, taking a pair formed of a traffic accident scene and an effective route Rb as knowledge, changes the format of the knowledge and stores the knowledge. For example, when an avoidance route “fully turn the steering wheel to the right and fully apply the brake” is the effective route Rb, an abstract description such as “TurnRight: full, brake: full” is set as the knowledge.

### Other Configurations

<Modification 1>

Some functions of the route generation device 100 described in the present embodiment may be executed by another device. For example, some functions of the route generation device 100 may be executed by a device such as an external server.

<Modification 2>

In the present embodiment, the functions of the accident data acquisition unit 110, traveling situation extraction unit 120, avoidance route generation unit 130, effectiveness determination unit 140, effective route selection unit 150, and effective information building unit 160 are implemented by software. According to a modification, the functions of the accident data acquisition unit 110, traveling situation extraction unit 120, avoidance route generation unit 130, effectiveness determination unit 140, effective route selection unit 150, and effective information building unit 160 may be implemented by hardware.

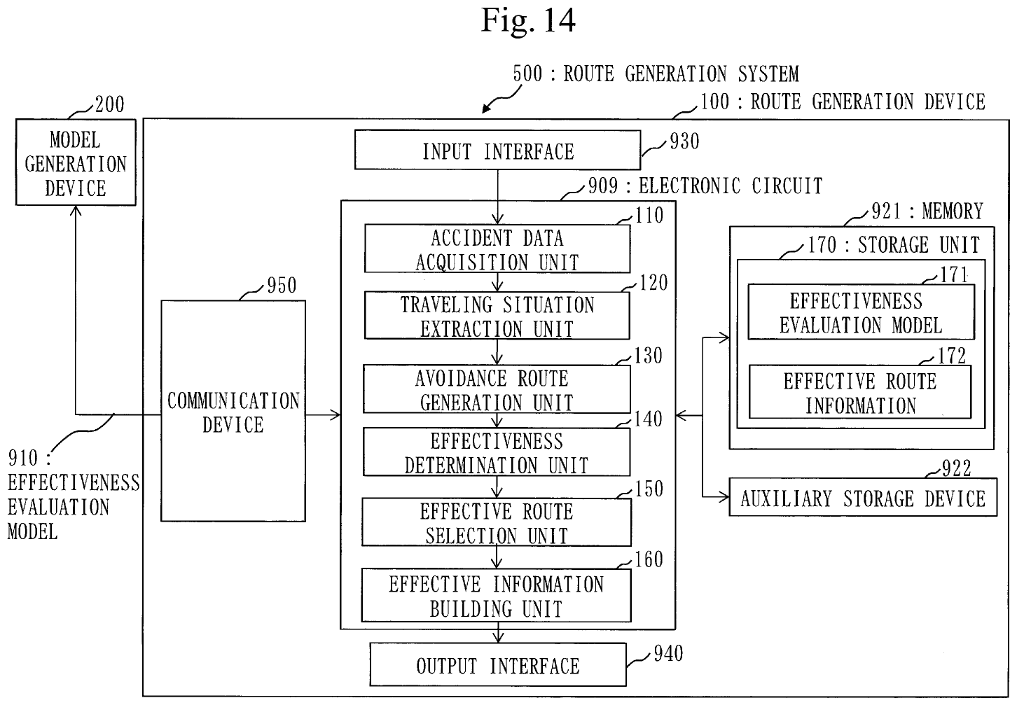

FIG. 14 is a diagram illustrating a configuration of a route generation device 100 according to a modification of the present embodiment.

The route generation device 100 is provided with an electronic circuit 909, a memory 921, an auxiliary storage device 922, an input interface 930, and an output interface 940.

The electronic circuit 909 is a dedicated electronic circuit that implements the functions of the accident data acquisition unit 110, traveling situation extraction unit 120, avoidance route generation unit 130, effectiveness determination unit 140, effective route selection unit 150, and effective information building unit 160.

The electronic circuit 909 is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array.

The functions of the accident data acquisition unit 110, traveling situation extraction unit 120, avoidance route generation unit 130, effectiveness determination unit 140, effective route selection unit 150, and effective information building unit 160 may be implemented by one electronic circuit, or may be implemented by a plurality of electronic circuits through distribution.

According to another modification, some of the functions of the accident data acquisition unit 110, traveling situation extraction unit 120, avoidance route generation unit 130, effectiveness determination unit 140, effective route selection unit 150, and effective information building unit 160 may be implemented by an electronic circuit, and the remaining functions may be implemented by software. According to still another modification, some or all of the functions of the accident data acquisition unit 110, traveling situation extraction unit 120, avoidance route generation unit 130, effectiveness determination unit 140, effective route selection unit 150, and effective information building unit 160 may be implemented by firmware.

The processor and the electronic circuit are also called processing circuitry. That is, in the route generation device 100, the functions of the accident data acquisition unit 110, traveling situation extraction unit 120, avoidance route generation unit 130, effectiveness determination unit 140, effective route selection unit 150, and effective information building unit 160 are implemented by processing circuitry.

### Description of Effect of Embodiment

In the route generation system according to the present embodiment, a necessary traveling situation of the time a traffic accident occurs is extracted in advance from an existing huge traffic accident database. The traveling situation includes information such as a collision speed, a collision target, and a road surface condition. The route generation system designs an avoidance traveling route for emergency (emergency avoidance route) on the basis of the extracted information. Also, the route generation system builds a knowledge base by combining, as a pair, the traveling situation of the time the traffic accident described above has occurred and the designed emergency avoidance route. When a dangerous traffic scene actually occurs, the route generation system receives an own vehicle situation, an obstacle situation, or a surrounding traffic situation from a sensor device. Thus, the route generation system can search for an optimum emergency avoidance route in the knowledge base built in advance. An emergency avoidance route against a traffic accident that is most similar to a present dangerous traffic scene is outputted onto the knowledge base, and emergency avoidance can be performed.

Therefore, with the route generation system according to the present embodiment, an appropriate emergency avoidance route can be generated from an actually occurring traffic situation. Hence, accidents can be avoided or injuries in collision can be reduced, thereby realizing safe and secure autonomous driving and driving assistance.

In the route generation system according to the present embodiment, an effectiveness evaluation model is generated which records significance that derives the evaluation value from each avoidance route. Then, using the effectiveness evaluation model, an effective evaluation value that is most appropriate for the avoidance route is determined.

Therefore, with the route generation system according to the present embodiment, the most appropriate emergency avoidance route obtained from an actual traffic accident scene can be selected, and more safe, more secure autonomous driving and driving assistance can be realized.

The route generation system according to the present embodiment is provided with an effective route selection unit which selects the most effective avoidance route on the basis of the determined effective evaluation value, and a knowledge base building unit which builds a knowledge base by associating a traffic accident scene and an emergency avoidance route with each other.

Therefore, with the route generation system according to the present embodiment, the most appropriate emergency avoidance route can be selected, and more safe, more secure autonomous driving and driving assistance can be realized.

The route generation system according to the present embodiment is provided with a learning data storage unit to store a learning data set in which an avoidance route and an effective evaluation value are formed as a pair. First, a learning data set is formed according to subjective evaluation. The route generation system is also provided with a feature quantity extraction unit to extract, from learning data, a feature quantity for evaluating effectiveness. The route generation system is also provided with an evaluation model generation unit to generate an effectiveness evaluation model from the learning data. The evaluation model generation unit learns evaluation models of a plurality of avoidance routes in advance by a statistical method. The route generation system generates the plurality of avoidance routes from information such as a direction and velocity of the own car. In implementation, an avoidance route having the highest effective evaluation value is outputted.

Therefore, with the route generation system according to the present invention, an effectiveness evaluation model that is more effective and based on an actual traffic accident scene can be generated, and an avoidance route that is most appropriate for an actually occurring traffic accident scene can be outputted.

In Embodiment 1 described above, the individual units of each device of the route generation system are described as independent function blocks. However, each device of the route generation system does not necessarily have a configuration like that described in the above embodiment. The function blocks of each device of the route generation system may be of any configuration as far as they can implement the functions described in the above embodiment. Each device of the route generation system may be a system constituted of a plurality of devices, instead of one device.

Of Embodiment 1, a plurality of portions may be combined and practiced. Alternatively, of the present embodiment, one portion may be practiced. Furthermore, the present embodiment may be practiced entirely or partly by any combination.

That is, in Embodiment 1, an arbitrary combination of portions of the embodiment, a modification of an arbitrary constituent element of the embodiment, and omission of an arbitrary constituent element of the embodiment are possible.

Note that the embodiment described above is an essentially preferable exemplification and is not intended to limit a scope of the present invention, a scope of an applied product of the present invention, and a scope of usage of the present invention. Various changes can be made to the embodiment described above as necessary.

### REFERENCE SIGNS LIST

40: a plurality of avoidance routes; 100: route generation device; 110: accident data acquisition unit; 120: traveling situation extraction unit; 130: avoidance route generation unit; 140: effectiveness determination unit; 150: effective route selection unit; 160: effective information building unit; 170: storage unit; 171: effectiveness evaluation model; 172: effective route information; 200: model generation device; 210: learning data storage unit; 211: learning data set; 220: feature quantity extraction unit; 230: evaluation model generation unit; 301: own vehicle; 302: another vehicle; 500: route generation system; 909: electronic circuit; 910: processor; 921: memory; 922: auxiliary storage device; 930: input interface; 940: output interface; 950: communication device; P: effective evaluation value; T: feature quantity; Si: feature quantity score; V: feature quantity vector; S: final score.

1. A route generation system comprising:
processing circuitry
to extract, from a traffic accident database in which traffic accident scene information expressing a situation of the traffic accident scene is accumulated, a traveling situation of a vehicle corresponding to the traffic accident scene,
to generate a plurality of avoidance routes to avoid the traffic accident scene on a basis of the traveling situation,
to determine an effective evaluation value of each of the plurality of avoidance routes using an effectiveness evaluation model indicating correspondence between an effective evaluation value which expresses effectiveness of an avoidance route and a feature quantity which expresses a feature of the avoidance route,
to select a most effective avoidance route as an effective route from among the plurality of avoidance routes, on the basis of the effective evaluation value of each of the plurality of avoidance routes,
to store effective route information in which the traffic accident scene and the effective route are associated with each other, and
to generate the effectiveness evaluation model,
wherein the processing circuitry
stores a learning data set in which each of the plurality of avoidance routes and a subjective evaluation value being a value expressing an effectiveness are associated with each other, the subjective evaluation value being set in advance,
extracts a feature quantity vector expressing feature quantities to evaluate effectiveness of each of the plurality of avoidance routes on the basis of the learning data set, and
generates the effectiveness evaluation model using the feature quantity vector of each of the plurality of avoidance routes.

2. The route generation system according to claim 1,
wherein the processing circuitry calculates, for each of the plurality of avoidance routes, a final score expressing a height of probability that an effective evaluation value might be obtained about each of the plurality of effective evaluation values, using the effectiveness evaluation model and the feature quantity vector of each of the plurality of avoidance routes, and determines an effective evaluation value having a highest final score, as an effective evaluation value of an avoidance route in question, among the plurality of effective evaluation values.

3. A route generation system comprising:
processing circuitry
to extract, from a traffic accident database in which traffic accident scene information expressing a situation of the traffic accident scene is accumulated, a traveling situation of a vehicle corresponding to the traffic accident scene,
to generate a plurality of avoidance routes to avoid the traffic accident scene on a basis of the traveling situation,
to determine, for each of the plurality of avoidance routes, a value that expresses effectiveness, as an effective evaluation value,
to select a most effective avoidance route as an effective route from among the plurality of avoidance routes, on the basis of the effective evaluation value of each of the plurality of avoidance routes, and
to store effective route information in which the traffic accident scene and the effective route are associated with each other,
wherein the processing circuitry calculates, for each of the plurality of avoidance routes, a final score expressing a height of probability that an effective evaluation value might be obtained about each of the plurality of effective evaluation values, using an effectiveness evaluation model indicating correspondence between the effective evaluation value and a feature quantity which expresses a feature of the avoidance route, and a feature quantity vector of each of the plurality of avoidance routes, and determines an effective evaluation value having a highest final score, as an effective evaluation value of an avoidance route in question, among the plurality of effective evaluation values.

4. The route generation system according to claim 2,
wherein the processing circuitry calculates feature quantity scores of the feature quantities per effective evaluation value of the plurality of effective evaluation values, and calculates a sum of the feature quantity scores as the final score.

5. The route generation system according to claim 1,
wherein the processing circuitry generates the plurality of avoidance routes using the traveling situation including a velocity and a direction of a vehicle corresponding to the traffic accident scene.

6. The route generation system according to claim 1,
wherein the processing circuitry stores the effective route information in a knowledge-base format.

7. A route generation method comprising:
extracting, from a traffic accident database in which traffic accident scene information expressing a situation of a traffic accident scene is accumulated, a traveling situation of a vehicle corresponding to the traffic accident scene;
generating a plurality of avoidance routes to avoid the traffic accident scene on a basis of the traveling situation;
determining an effective evaluation value of each of the plurality of avoidance routes using an effectiveness evaluation model indicating correspondence between an effective evaluation value which expresses effectiveness of an avoidance route and a feature quantity which expresses a feature of the avoidance route;
selecting a most effective avoidance route as an effective route from among the plurality of avoidance routes on the basis of an effective evaluation value of each of the plurality of avoidance routes; and
storing effective route information in which the traffic accident scene and the effective route are associated with each other,
the route generation method further comprising:
storing a learning data set in which each of the plurality of avoidance routes and a subjective evaluation value being a value expressing an effectiveness are associated with each other, the subjective evaluation value being set in advance;
extracting a feature quantity vector expressing feature quantities to evaluate effectiveness of each of the plurality of avoidance routes on the basis of the learning data set; and
generating the effectiveness evaluation model using the feature quantity vector of each of the plurality of avoidance routes.

8. A route generation method comprising:
extracting, from a traffic accident database in which traffic accident scene information expressing a situation of a traffic accident scene is accumulated, a traveling situation of a vehicle corresponding to the traffic accident scene;
generating a plurality of avoidance routes to avoid the traffic accident scene on a basis of the traveling situation;
calculating, for each of the plurality of avoidance routes, a final score expressing a height of probability that an effective evaluation value might be obtained about each of the plurality of effective evaluation values, using an effectiveness evaluation model indicating correspondence between an effective evaluation value which expresses effectiveness of an avoidance route and a feature quantity which expresses a feature of the avoidance route, and a feature quantity vector of each of the plurality of avoidance routes, and determining an effective evaluation value having a highest final score, as an effective evaluation value of an avoidance route in question, among the plurality of effective evaluation values;
selecting a most effective avoidance route as an effective route from among the plurality of avoidance routes on the basis of an effective evaluation value of each of the plurality of avoidance routes; and
storing effective route information in which the traffic accident scene and the effective route are associated with each other.

9. A non-transitory computer readable medium recorded with a route generation program which causes a computer to execute:
a traveling situation extraction process of extracting, from a traffic accident database in which traffic accident scene information expressing a situation of a traffic accident scene is accumulated, a traveling situation of a vehicle corresponding to the traffic accident scene;
an avoidance route generation process of generating a plurality of avoidance routes to avoid the traffic accident scene on a basis of the traveling situation;
an effectiveness determination process of determining an effective evaluation value of each of the plurality of avoidance routes using an effectiveness evaluation model indicating correspondence between an effective evaluation value which expresses effectiveness of an avoidance route and a feature quantity which expresses a feature of the avoidance route;
an effective route selection process of selecting a most effective avoidance route as an effective route from among the plurality of avoidance routes, on the basis of the effective evaluation value of each of the plurality of avoidance routes; and
an effective information building process of storing effective route information in which the traffic accident scene and the effective route are associated with each other,
the route generation program further causing the computer to execute:
a learning data storage process of storing a learning data set in which each of the plurality of avoidance routes and a subjective evaluation value being a value expressing an effectiveness are associated with each other, the subjective evaluation value being set in advance;
a feature quantity extraction process of extracting a feature quantity vector expressing feature quantities to evaluate effectiveness of each of the plurality of avoidance routes on the basis of the learning data set; and
an evaluation model generation process of generating the effectiveness evaluation model using the feature quantity vector of each of the plurality of avoidance routes.

10. A non-transitory computer readable medium recorded with a route generation program which causes a computer to execute:
a traveling situation extraction process of extracting, from a traffic accident database in which traffic accident scene information expressing a situation of a traffic accident scene is accumulated, a traveling situation of a vehicle corresponding to the traffic accident scene;
an avoidance route generation process of generating a plurality of avoidance routes to avoid the traffic accident scene on a basis of the traveling situation;
an effectiveness determination process of determining, for each of the plurality of avoidance routes, a value that expresses effectiveness, as an effective evaluation value;
an effective route selection process of selecting a most effective avoidance route as an effective route from among the plurality of avoidance routes, on the basis of the effective evaluation value of each of the plurality of avoidance routes; and
an effective information building process of storing effective route information in which the traffic accident scene and the effective route are associated with each other,
wherein the effectiveness determination process includes calculating, for each of the plurality of avoidance routes, a final score expressing a height of probability that an effective evaluation value might be obtained about each of the plurality of effective evaluation values, using an effectiveness evaluation model indicating correspondence between the effective evaluation value and a feature quantity which expresses a feature of the avoidance route, and a feature quantity vector of each of the plurality of avoidance routes, and determining an effective evaluation value having a highest final score, as an effective evaluation value of an avoidance route in question, among the plurality of effective evaluation values.
